(19) United States
(12) Patent Application Publication
(10) Pub. No.: US 2015/0377410 A1
(43) Pub. Date: Dec. 31, 2015

(54) ATTACHMENT FITTING FOR COUPLING WITH EXTERNAL DEVICES

(71) Applicant: Vitalli Mykolalovych BORYSENKO, Kharkiv (UA)

(72) Inventor: Vitalii Mykolaiovych BORYSENKO, Kharkiv (UA)

(21) Appl. No.: 14/768,221

(22) PCT Filed: Nov. 18, 2013
(86) PCT No.: PCT/UA2013/000134

§ 371 Date: Aug. 15, 2015

(30) Foreign Application Priority Data
Feb. 22, 2013 (UA) U 2013 02267

(51) Int. Cl. F16M 11/04

(52) U.S. Cl. CPC F16M 11/041

(57) ABSTRACT

The invention belongs to the field of human life and activities and can be used as an attachment fitting for coupling with various external mobile devices and means installed on boats or other transport means such as vehicles, bicycles, motorbikes, etc. The attachment fitting for coupling with external devices comprising the casing with fasteners in which the axial central opening is executed, circumferentially of which the splines are disposed with the possibility of turning of the spline join through an angle from 15 to 40 degrees, the locking mechanism disposed in the gutter on the side face of the casing with the possibility of the transverse movement and executed in the form of the plate with the shaped opening having the splines on the inner part which are disposed circumferentially, and the shaped segment executed with the deviation from the circle centre on the value of not less than two heights of the spline tooth. This technical solution allows to increase the reliability of fixing on the transport means, prove fixation of the axial movement of the devices as well as to improve performance characteristics that allows to dispose the device located on it in the required position without attachment rigidity loss.

The invention belongs to the field of human life and activities and can be used as an attachment fitting for coupling with various external mobile devices and means installed on boats and other transport means such as vehicles, bicycles, motorbikes, etc.

For example, the attachment fitting can be installed on the body, sides or other places of the boat for fixing removable carriers such as rod rests, hand rope rests, table and vessels rests, for fixing navigational and communication equipment and other devices.

The attachment fitting [1] is known comprising an outer casing with fasteners disposed at the ends and a gutter for mounting an assembly component representing a shaped plate of the right-angled form in the centre of which the ball of the turning gear is fixed. Laterally on the attachment fitting of the removable carriers a locking mechanism is disposed in the form of the spring loaded lever arm which fixes the shaped plate of he right-angled form in the stationary position. The attachment fitting can be used for mounting such removable devices as a camera or a fishrod on a boat side that provides their fixation and improves serviceability of these devices.

Disadvantage of this technical solution is unreliable fixation of removable devices due to existence of the ball-and-socket mounting of removable elements. As the ball-and-socket mounting has limitations concerning the force value at setting the turning angle in case of excess of the applying force appearing at irregular motion of the transport object it can lead to abrupt change of the removable carrier position that decreases reliability of the device fixation. Besides, entering of various impurities and water into the outer casing with the gutter from the environment is also possible that can lead to corrosion and jamming of the locking mechanism that also decreases reliability of the attachment filling in whole.

The closest analogous solution to the applied technical solution is the attachment fitting for coupling with external devices [2] comprising the casing in which an axial central opening is disposed, circumferentially of which the splines are disposed as well as the locking mechanism positioned in the gutter on the side face of the casing with the possibility of the cross motion and executed in the form of the plate with a spline element, at that fasteners are disposed on the outer face of the casing. Eight splines of the axial central opening are disposed circumferentially with the possibility of turning of the spline joint at mounting of the replacement adapter with the external device at an angle of 45°.

On the side face of the casing of the attachment fitting the gutter is disposed in which the locking mechanism moves in the transverse direction which is executed in the form of the plate with the spline element. At that one spline element is disposed on the plate which is executed in the form of the gutter and situated on the side face of this plate. At mounting through the adapter of the removable device the attachment fitting the spline element of the plate forms the spline joint with the splines of the axial central opening of the attachment fitting.

In the installation position the plate gutter and the axial central opening spline coincide that provides the possibility of free axial movement of the replacement adapter with the external device. At the transverse displacement of the plate from one full shift position to the other one it passes through the circular groove in the adapter and covers one of the splines thus preventing the axial movement of the installed adapter of the removable carrier.

On the outer face of the casing two fasteners are disposed which allow to install the attachment fitting on the various means of transport.

However, this technical solution has such a disadvantage as the big setting angle of the replacement adapter with the external device which constitutes 45 degrees that reduces functionality and leads to inconvenience in the process of exploitation as it does not allow to set up the movable carrier more precisely. One more disadvantage is low reliability of fixation of the axial movement of the adapter in the attachment fitting as the plate of the locking mechanism fixes the adapter only by means of one tooth. Besides, this device is not mounted reliably enough on the casing of the transport means due to the presence of only two assembly components as a result of which the entire device reliability decreases.

The objective of the utility model is creation such the attachment fitting for coupling with external devices in which increasing of the reliability and improving of the performance characteristics is achieved by means of the construction improvement.

The objective is achieved by that in the known attachment fitting for coupling with the external devices comprising the casing in which the axial central opening is disposed, circumferentially of which the splines are disposed, the locking mechanism which is disposed in the gutter on the side face of the casing with the possibility of the transverse movement and executed in the form of the plate with the spline element, and on the outer face of the casing fasteners are disposed, according to the invention, the splines of the axial central opening of the casing are executed with the possibility of turning of the spline joints through an angle from 15 to 40 degrees, at that a shaped opening is executed on the plate having the splines on the inner part which are disposed circumferentially, and a shaped segment executed with the deviation from the circle centre.

Besides the spline spacing on the plate is executed in accordance with the spline spacing of the axial central opening of the casing.

At that the deviation of the shaped segment on the plate from the circle centre is not less than the value of two heights of the spline tooth.

Besides, the casing contains additional fasteners disposed symmetrically along its transverse axis.

The proposed construction provides precise and reliable coupling at the installation of external devices on any surface due to that the splines of the axial central opening of the casing are executed with the possibility of turning of the spline joint through an angle from 15 to 40 degrees. At such the execution of the spline joint not only the device reliability increases but also its performance characteristics are improved providing convenience of exploitation.

Execution of the locking mechanism in the form of the plate with the shaped opening having the splines on the inner part which are disposed circumferentially and the shaped segment executed with the deviation from the circle centre, allows to fix the replacement adapter of the external device securely.

Execution of the spline spacing on the plate in accordance with the spacing of the splines of the axial central opening of the casing, and the deviation of the shaped segment on the plate from the circle centre by the value of not less than two heights of the spline tooth allows to enter freely the adapter of the removable device into the casing of the attachment fitting in the position of the plate as “open”, and in the position of the plate as “closed” the shaped segment allows to securely fix the adapter preventing the axial movement.

Execution of the casing of the attachment fitting of the removable carriers with the additional fasteners allows to distribute the load more uniformly on the whole contact area of the attachment fitting casing and the transport means surface on which the device is mounted, and to fix the attachment fitting more securely on it.

The essence of the utility model is illustrated on the drawings as follows:

FIG. 1—general view of the attachment fitting for coupling with external devices

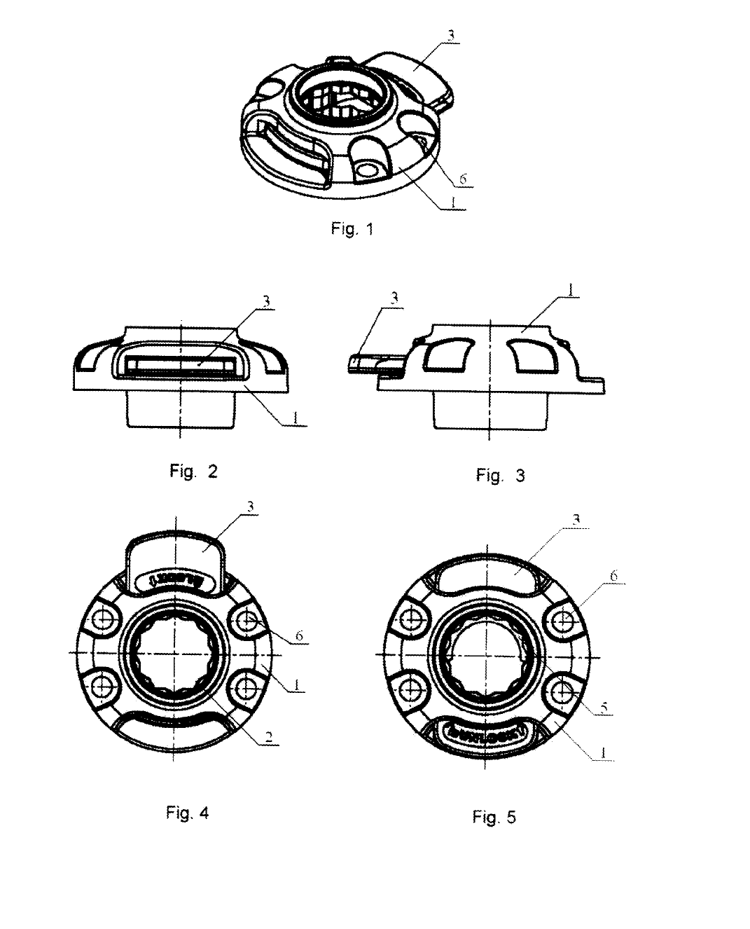

FIG. 2—front view of the attachment fitting for coupling with external devices

FIG. 3—side view of the attachment fitting for coupling with external devices

FIG. 4—top view of the attachment fitting for coupling with external devices in the position “open”

FIG. 5—top view of the attachment fitting for coupling with external devices in the position “closed”

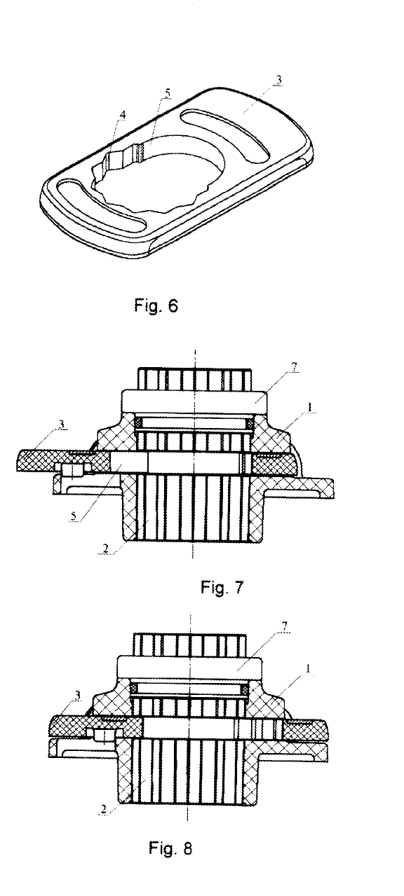

FIG. 6—general view of the plate of the attachment fitting for coupling with external devices

FIG. 7—cross section of the attachment fitting for coupling with external devices with the installed adapter in the position “open”

FIG. 8—cross section of the attachment fitting for coupling with external devices with the installed adapter in the position “closed”.

The attachment fitting for coupling with external devices comprises the casing (1) in which the axial central opening is executed circumferentially of which the splines (2) are disposed. On the side face of the casing the gutter is disposed in which the locking mechanism is disposed in the form of the plate (3) with the possibility of the transverse movement. On the plate (3) the shaped opening is executed having the splines (4) on the inner part which are disposed circumferentially and the shaped segment (5) executed with the

deviation from the circle centre. Four fasteners (6) are disposed on casing (1) of the attachment fitting for coupling with external devices.

The attachment fitting for coupling with external devices is intended for installation of any kind of mobile devices, as well as supports, holders, shelves, extensions and other supporting elements having a transitional adapter on various transport means. The casing of the attachment fitting (1) is fixed directly on the outer face of the transport means with the help of fasteners (6) or is installed with the help of any known transitional elements. In the middle of the casing (1) the axial central opening with splines is disposed in which the replacement adapter (7) with the device of the appropriate kind located on it is disposed. Due to the spline joint the adapter can be installed with the possibility of the deviation through the angle from 15 to 40 degrees that allows to dispose the device located on it in the required position without attachment rigidity loss.

On the side face of the casing (1) the gutter is disposed in which he plate (3) moves being the locking mechanism of the device. In the position “open” the splines of the shaped element of the plate (3) coincide with the splines of the opening in the casing and allow the adapter (7) to move in the axial direction. After the installation of the adapter at a required angle it is fixed by means of movement of the plate (3) to the position (closed), at that the shaped segment (5) executed with the deviation from the circle centre enters the groove on the adapter covering it diametrically at an angle of 180 degrees. The plate of the locking element fixes securely the adapter and prevents its axial movement.

The attachment fitting can be installed on the casing, sides or other places of the boat or other transport means and provides secure fixing of removable carriers such as rod rests, hand rope rests, table and vessels rests, for fixing navigational and communication equipment and other devices.

Thus, the applied utility model of the attachment fitting for coupling with external devices allows to increase reliability of fixing on the transport means, improve fixation of the axial movement of the devices as well as to improve performance characteristics that allows to dispose the device located on it in the required position without attachment rigidity loss.

1. An attachment fitting for coupling with external devices comprising:
a casing in which the axial central opening is executed circumferentially of which splines are disposed,
a locking mechanism disposed in a gutter on the side face of the casing with the possibility of transverse movement and executed in the form of a plate with the splines at that fasteners are disposed on the outer face of the casing, and
the splines of the axial central opening of the casing are executed with the possibility of turning of the spline joint through an angle from 15 to 40 degrees, at that the shaped opening is executed on the plate having the splines on the inner part which are disposed circumferentially and a shaped segment executed with the deviation from the circle centre.

2. The attachment fitting as set forth in claim 1 wherein the spline spacing on the plate is executed in accordance with the spline spacing of the axial central opening of the casing.

3. The attachment fitting as set forth in claim 1 wherein the deviation of the shaped segment on the plate from the circle centre is not less than the value of two heights of the spline tooth.

4. The attachment fitting as set forth in 1 wherein the casing contains additional fasteners disposed symmetrically along its transverse axis.
